(19) United States
(12) Patent Application Publication
(10) Pub. No.: US 2022/0383077 A1
(43) Pub. Date: Dec. 1, 2022

(54) Computer-Implemented Method of Executing SoftMax

(71) Applicant: Aptiv Technologies Limited, St. Michael (BB)

(72) Inventor: Christof Petig, Wuppertal (DE)

(21) Appl. No.: 17/663,742

(22) Filed: May 17, 2022

(30) Foreign Application Priority Data
May 18, 2021 (EP) 21174394.3

(51) Int. Cl. G06N 3/04; G06F 1/03; G06F 7/50; G06F 7/523; G06F 5/01

(52) U.S. Cl. CPC G06N 3/0481; G06F 1/03; G06F 7/50; G06F 7/523; G06F 5/01

(57) ABSTRACT

The present disclosure concerns a method of executing a SoftMax function, the method comprising: (i) pre-storing in memory M fraction components (fcⱼ) in binary form, derived from the expression 2^{(j/M)}, said fcⱼ forming a lookup table (T) of size M; (ii) calculating, for each zᵢ, an element yᵢ of a number of the form 2^{y}^{ᵢ}; (iii) separating yᵢ into an integral part (intᵢ) and a fractional part (fractᵢ); (iv) determining a lookup index (indᵢ) that corresponds to fractᵢ scaled by the size M; (v) retrieving a fraction component fcᵢ from T with indᵢ; (vi) generating, in a result register, a binary number representative of the exponential value of said zᵢ, by combining said fcᵢ retrieved from T and said intᵢ; (v) adding the K result registers corresponding to zᵢ into a sum register R7; and (vi) determining the K probability values pᵢ from the K result registers and the sum register.

### CROSS-REFERENCE TO RELATED APPLICATION(S)

This application claims priority to European Patent Application Number 21174394.3, filed May 18, 2021, the disclosure of which is hereby incorporated by reference in its entirety.

### BACKGROUND

A SoftMax function takes as input a vector z of K real numbers z; with i=1, . . . , K and can be defined by the following mathematical formula:

$${σ ( z )}_{i} = \frac{{e}^{{z}_{i}}}{{\sum }_{j = 1}^{K} {e}^{{z}_{j}}} for i = 1 , … , K and z = ( {z}_{1} , … , {z}_{K} ) ∈ {ℝ}^{K}$$

The SoftMax function normalizes the vector z into a probability distribution consisting in K probabilities proportional to the exponentials of the input numbers. After applying the SoftMax function, each component may be in the interval (0,1) and the components may add up to 1.

Such a function can be used for example as the last activation function of a neural network, for example a classification neural network, to normalize the output of the neural network to a probability distribution over predicted output classes.

Consider a classification neural network for recognition of cats and dogs. With reference to FIG. 1, the neural network can be fed in input with an image and outputs a vector x that includes for example 2.5 for a cat and 0.5 for a dog and 1.5 for unknown. Ina step S1, the SoftMax function running on a processor can first subtract the maximal input value 2.5 to turn the original input values 2.5, 0.5 and 1.5 into new input values 0, −2, −1 that can be either negative or zero. Then, the SoftMax function can calculate the exponentials of the input values exp(0), exp(−2), exp(−1) in a step S2, add the exponentials in a step S3, and normalize the output in a step S4, by dividing each exponential by the sum of the exponentials, to obtain output values between 0 and 1 that add up to 1. These output values provide a distribution of probabilities. In the given illustrative example, the distribution of probabilities includes 56% for a cat, 11% for a dog, and 33% for unknown.

The SoftMax function makes a non-linear mapping: the most probable outcomes are amplified and the less probable outcomes (non-meaningful) can be significantly reduced or even suppressed. The sum of the probabilities (percentages) of the different classes may be 100%. Such a non-linear mapping can be done using the exponential function. The output of the neural network can be quite evenly distributed, and its decision may be unclear. The SoftMax function allows to amplify the output components by an exponential function and the result can be normalized to one.

To execute the SoftMax function, the processor needs to calculate an exponential function, which can be very costly in computing resources. The processor uses floating-point operations represented by dotted boxes in FIG. 1. It takes a lot of computing cycles, run time and energy. Furthermore, in a microcontroller, with more limited capacities than other processors, floating-point numbers are avoided because they involve a higher energy consumption and a higher demand on processor resources. Therefore, there is a need to reduce computing resource(s) expenditure while the SoftMax function executes on a processor or a data processing device.

### SUMMARY

The present disclosure concerns a computer-implemented method of executing a SoftMax function on K input number zᵢ, with 1≤i≤K, carried out by a data processing device (100) including the computation, for each input number zᵢ, of a probability value pᵢ that is equal to the exponential value of said input number zᵢ divided by a sum Σ of the exponential values of the K input number zᵢ; characterized in that the data processing device: (i) pre-stores in memory M fraction components fcⱼ in binary form, derived from the expression

$${2}^{( \frac{j}{M} )}$$

where j is an integer varying from 0 to M−1, said M fraction components forming a lookup table of size M; (ii) for each input number zᵢ, calculates an element yᵢ of a number of the form 2^{y}^{ᵢ} where yᵢ represents

$$\frac{{z}_{i}}{ln ( 2 )} ;$$

(iii) separates the element yᵢ into an integral part intᵢ and a fractional part fractᵢ; (iv) determines a lookup index indᵢ that corresponds to the fractional part fractᵢ scaled by the size M; (v) retrieves the fraction component fcᵢ from the lookup table with the obtained lookup index indᵢ; (vi) generates, in a result register, a binary number qᵢ representative of the exponential value of said input number zᵢ, by combining said fraction component fcᵢ retrieved from the lookup table and said integral part intᵢ; (v) adds the K result registers corresponding to the K input numbers zᵢ into a sum register R7; and (vi) determines the K probability values pᵢ from the K result registers and the sum register.

In the present disclosure, the calculation by the exponential function can be avoided. The exponentiation can be turned into an exponentiation of 2 and a lookup table storing binary fraction components fcⱼ derived from the expression

$${2}^{( \frac{j}{M} )}$$

may be used, which allows to simplify the operations and calculations within binary registers in the data processing device. The cost in computing resources to implement the SoftMax function can be significantly reduced.

In an implementation, the method further includes a preliminary step of computing the M fraction components fcⱼ of the lookup table, with j varying from 0 to M−1, by using the following formula:

$$f {c}_{j} = a * {2}^{( b * ( \frac{j}{M} ) + c )} - d ,$$

where a, b, c and d are constant parameters; b can be either 1 or −1; a may include an output scaling factor Sₒᵤₜ, where Sₒᵤₜ can be equal to 2^{B} and B may be a number of desired bits for the computed exponential values; d can be a multiple of a. Further, the parameters a, b, c, and d for computing the fraction components fcⱼ can be adjusted in a way that the largest fraction component may be equal or close to 2^{B}−1.

In implementations, each input number zᵢ in binary form may be scaled by an input scaling factor Sᵢₙ=2^{σ} so as to be stored in a first N-bit register. The input scaling factor Sᵢₙ may be determined depending on the expected smallest and largest values of the numbers zᵢ and the size N of the first N-bit registers.

In an implementation, the step ii) of calculating each element yᵢ, with

$${y}_{i} = \frac{{z}_{i}}{ln ( 2 )} ,$$

may be carried out by the data processing device, and can include the following steps: providing the corresponding scaled input number zᵢ in the first N-bit register; right-shifting the scaled input number zᵢ by N/2−1; and processing the right-shifted scaled input number zᵢ according to the following processing rules to provide a transformed input number zᵢ″ into a second N/2-bit register.

If the scaled input number zᵢ, after right-shifting by N/2−1, does not overflow the second N/2-bit register, then the shifted scaled input number zᵢ can be fit into said second N/2-bit register. If the scaled input number zᵢ, after right-shifting by N/2−1, overflows the second N/2-bit register, then second N/2 bit register can be saturated. Providing the value of

$$( \frac{1}{ln ( 2 )} - 1 )$$

scaled by 2^{N/2-1} in binary form in a third N/2-bit register. Further steps may include, calculating the product of the second and third N/2-bit registers; storing the product result into a fourth N-bit register; and adding the first N-bit register and the fourth N-bit register, by implementing a saturating addition, to obtain an element yᵢ, that can be scaled by the input scaling factor Sᵢₙ, in a fifth N-bit register.

In an additional implementation, the step ii) of calculating each element yᵢ, can further include a step of rounding the right-shifted scaled input number zᵢ″ by adding 2^{N/2-2} to the scaled input number zᵢ before right-shifting by N/2−1.

In an implementation, the step ii) of calculating each element yᵢ, with

$${y}_{i} = \frac{{z}_{i}}{ln ( 2 )} ,$$

can be carried out by the data processing device, and can include the following steps: providing the corresponding scaled input number zᵢ in binary form in a first N-bit register; right-shifting the scaled input number zᵢ in binary form by N/2−2 in a second N-bit register; providing the value of

$$\frac{1}{ln ( 2 )} - 1$$

in binary form scaled by 2^{N/2-2} in a third register; multiplying the second N-bit register and the third register and storing the result into a fourth N-bit register; and adding the first and the fourth N-bit registers, by implementing a saturating addition, to obtain the element yᵢ scaled by the input scaling factor Sᵢₙ, in a fifth N-bit register.

In an additional implementation, the step ii) of calculating each element yᵢ, can further include a step of rounding the right-shifted scaled input number zᵢ by adding 2^{N/2-3} to the scaled input number zᵢ before right-shifting by N/2-2.

In an implementation, in the step vi), the binary number qᵢ representative of the exponential value of each input number zᵢ can be generated by inputting the corresponding fraction component fcᵢ retrieved from the lookup table into said result register and right-shifting said fraction component fcᵢ by the integral part intᵢ in said result register.

In that case, the parameters a, b, c and d for computing the fraction components of the lookup table can be adjusted in a way that the smallest fraction component can be close to 2^{B}/2, and the constant parameter d can be equal to zero.

The step of determining the K probability values pᵢ derived from the K input number zᵢ can include: adding the result registers with i varying from 1 to K to obtain a sum number Σ; obtaining a normalization factor fₙ by scaling a value V₁₀₀, obtained by setting to 1 all the bits in a result register and corresponding to a result qᵢ giving a probability value of 100%, by a normalization scaling factor Sₙ, according to the following expression:

$${f}_{n} = \frac{( {v}_{100} ≪ {s}_{n} )}{\sum }$$

where <<Sₙ may represent a left-shift by the normalization scaling factor Sₙ and applying the normalization factor fₙ to each result register with an inverse scaling by the normalization scaling factor Sₙ, to obtain a normalized result q_{i_n}, according to the following expression:

q_{i_n}=(qᵢ*fₙ)>>Sₙ

where >>Sₙ may represent a right-shift by Sₙ in the result register.

In an implementation, for precision improvement, the normalization factor fₙ can be rounded using the modified expression:

$${f}_{n} = \frac{( {v}_{100} ≪ {s}_{n} + \frac{\sum }{2} )}{\sum } .$$

For further precision improvement, the right-shift by Sₙ in the result register can also be combined with a rounding by adding 2^{Sn-1} to qᵢ*fₙ before right-shifting by Sₙ.

In another implementation, in the step vi), the binary number qᵢ representative of the exponential value of each input number zᵢ can be generated in said result register in the form of an IEEE 754 floating-point number including an exponent and a mantissa. The exponent can be a combination of the integral part intᵢ in binary form and the IEEE 754 exponent bias, and the mantissa can be derived from the fraction component fcᵢ and retrieved from the lookup table.

In such a case, the parameters a, b, c and d for computing the fraction components fcᵢ of the lookup table can be adjusted in a way that the fraction components of the lookup table match the IEEE 754 mantissa.

The method can further include a step of deriving each input numbers zᵢ from the corresponding input number zᵢ. For example, the method may include selecting the maximal input number xₘₐₓ for each input number zᵢ and performing one of the two following steps:
i) subtracting xₘₐₓ from xᵢ to obtain a negative or zero input number zᵢ; or
ii) subtracting xᵢ from xₘₐₓ to obtain a zero or positive input number zᵢ.

The above step can be performed on numbers already scaled by the input scaling factor.

The present disclosure also concerns a computer program including instructions which, when the program is executed by a computer, cause the computer to carry out the steps of the method previously defined; and a data processing device including a data processing device responsible for performing the steps of the method previously defined.

### BRIEF DESCRIPTION OF THE DRAWINGS

Other features, purposes and advantages of the disclosure may become more explicit by means of reading the detailed statement of the non-restrictive Implementations made with reference to the accompanying drawings.

FIG. 1 illustrates a method of executing a SoftMax function on a processor, according to the prior art;

FIG. 2 illustrates a method of executing a SoftMax function, according to a first implementation;

FIG. 3A is a table illustrating an example of original input numbers xᵢ in the first column and derived positive input numbers zᵢ in the second column;

FIG. 3B illustrates a table of numerical values;

FIG. 3C illustrates the registers R6ᵢ before and after normalization S20;

FIG. 4 is a flowchart of the step of the method of FIG. 2;

FIG. 5 illustrates a method of executing a SoftMax function, according to a second implementation;

FIG. 6 is a flowchart of the step of the method of FIG. 5;

FIG. 7 is a functional block diagram of a data processing device for executing the SoftMax function according to the first implementation; and

FIG. 8 illustrates a layout for a 32-bit floating point as defined by the IEEE standard for floating-point arithmetic (IEEE 754).

### DETAILED DESCRIPTION

The SoftMax function is a function that turns a vector of K input numbers (real values) into a vector of K output numbers (real values) that add up to 1. The input numbers can be positive, negative or zero. The SoftMax function transforms them into values between 0 and 1, that can be interpreted as probabilities. If one of the input number is small or negative, the SoftMax can turn it into a small probability, and if an input is positive and large, then it can turn it into a large probability.

A multi-layer neural network may end in a penultimate layer which can output real-valued scores that are not conveniently scaled. The SoftMax function can be used in the final layer, or last activation layer, of the neural network to convert the scores to a normalized probability distribution, which can be displayed to a user or used as input to another system.

Further, the SoftMax function can use the following mathematical formula to compute output values between 0 and 1:

$${σ ( z )}_{i} = \frac{{e}^{{z}_{i}}}{{\sum }_{j = 1}^{K} {e}^{{z}_{j}}} for i = 1 , … , K and z = ( {z}_{1} , … , {z}_{K} ) ∈ {ℝ}^{K} \qquad ( 1 )$$

where zᵢ may represent an input number (real value); σ(z)ᵢ may represent an output value (real value); and K can be the total number of input numbers.

The implementation of the SoftMax function can involve a floating-point calculation of the exponential function for each input number zᵢ. The calculation of the exponentials e^{z}^{ᵢ} is often costly in terms of computing resources and energy consumption. It takes a lot of computing cycles and runtime.

The present disclosure concerns a computer-implemented method of executing the SoftMax function on a data processing device 100, that requires fewer computing efforts and less runtime.

In the present disclosure, the exponentiation is turned into an exponentiation of two according to the following mathematical relationship:

$${e}^{{z}_{i}} = {( {2}^{{log}_{2} e} )}^{{z}_{i}} = {2}^{{log}_{2} e * {z}_{i}} = {2}^{{y}_{i}} \\ where {y}_{i} = {log}_{2} e * {z}_{i} = \frac{1}{ln ( 2 )} * {z}_{i} and \frac{1}{ln ( 2 )} ≅ 1.442695041 . \qquad ( 2 )$$

A computer (or a processor) may be more efficient and perform fewer computing cycles at calculating two to the power of a given exponent than the exponential function.

In the present disclosure, the computer-implemented method of executing the SoftMax function on the data processing device 100 is based on an exponentiation of two and uses a lookup table T of a small size to reduce the calculation efforts. The present method replaces the floating-point calculation of the exponential function by some shifts in registers, integer additions and integer multiplications, and limits the floating-point operations.

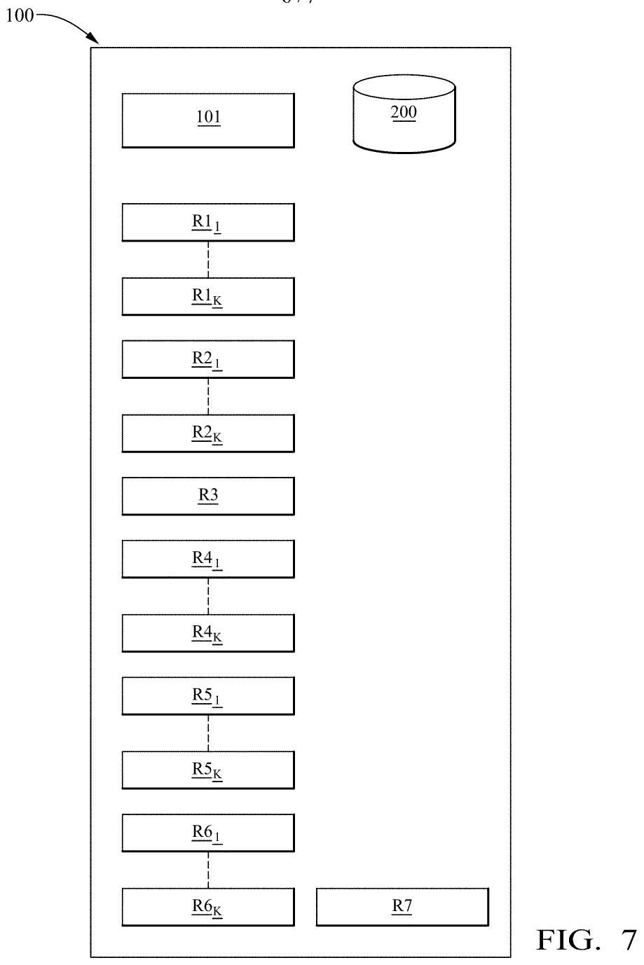

The computer-implemented method of the present disclosure can be implemented on a data processing device 100, represented in FIG. 7, that has a processor 101, a memory 200 for storing the lookup table T, and registers. In an implementation, the registers include N-bit registers and N/2-bit registers. The number N is may be of the form 2ⁿ, n being an integer with n≥1. A N/2-bit register can be implemented using half of a N-bit register. For example, N may be equal to 32. However, N can have any other value, for example 16 or 64.

In a preliminary step S10 of the method, a lookup table T can be computed and stored in the memory 200 in the data processing device 100. The lookup table T can be computed by the data processing device 100 itself, or by any other data processing device and then transferred to the data processing device 100.

The lookup table T can contain M fraction components fcⱼ in binary form, all derived from the expression

$${2}^{( \frac{j}{M} )}$$

where j can be a lookup index consisting in an integer varying from 0 to M−1. For example, M can be equal to 256. However, any other size M of the lookup table T, preferably of the kind M=2^{m} (m being an integer), can be used.

The computation of the M fraction components fcⱼ of the lookup table T (with 0≤j≤M−1) can be calculated using the following expression:

$$f {c}_{j} = a * {2}^{( b * ( \frac{j}{M} ) + c )} - d \qquad ( 3 )$$

where a, b, c and d are constant parameters; b can be either 1 or −1; a can include an output scaling factor Sₒᵤₜ, where Sₒᵤₜ is equal to 2^{B} and B is a number of desired bits for the computed exponential values; and d can be a multiple of a.

The lookup table T can store, in order, M fraction components fcⱼ with j going from 0 to M−1, the index j giving the position of the fraction component fcⱼ in the lookup table T. The expression (3) covers different variants of the lookup table T. In different implementations that may be described later, different variants of the lookup table T defined by the expression (3), based on different sets of constant parameters a, b, c, and d that are used.

In an implementation, the number B of desired bits for the results, namely for the exponential values computed by the present method, can be derived from the size N (in number of bits) in registers. For example, B can be equal to N/2. In case that N is 32, B can be equal to 16. B can be equal to any other value, preferably of the type 2^{m}, m being an integer.

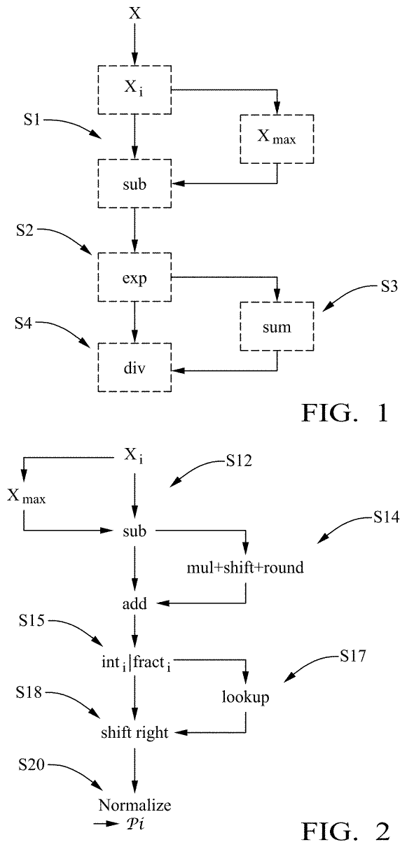

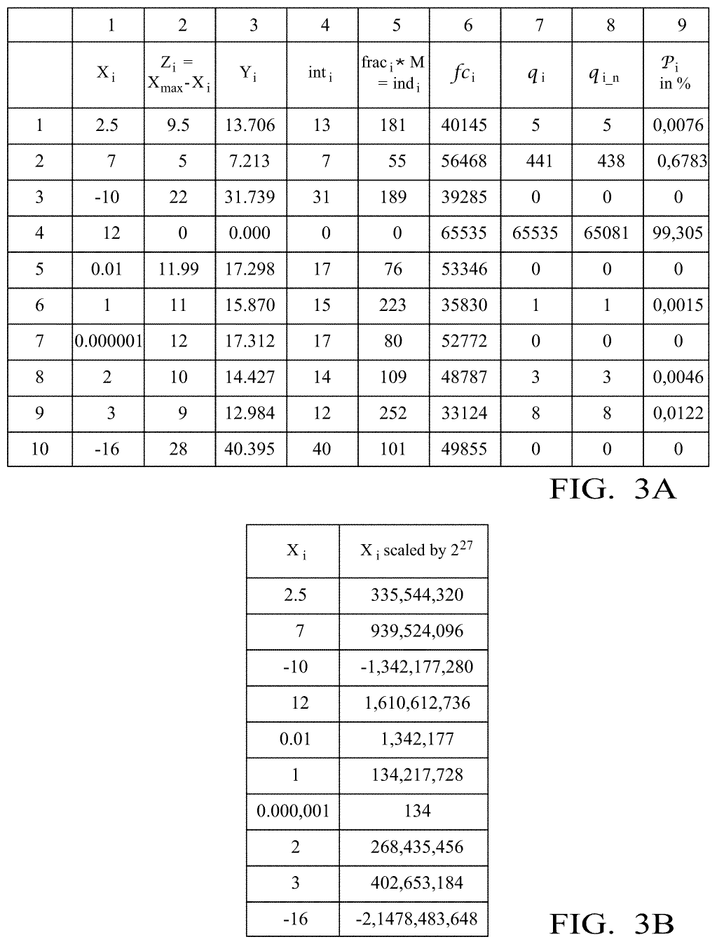

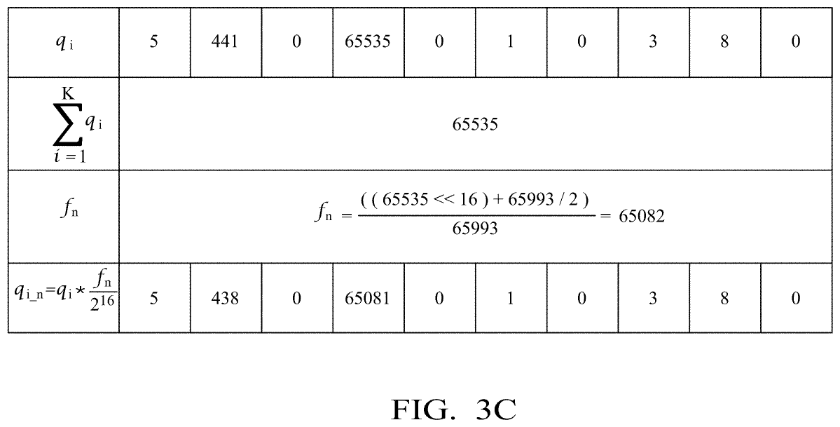

A first implementation of the computer-implemented method of executing the SoftMax function on the data processing device 100, that can be termed as a positive and fixed-point approach, may now be described with reference to FIGS. 2 and 3A-3C.

The first implementation uses a first variant of the lookup table T1. The constant parameters for computing the fraction components fcⱼ of the lookup table T1 are set as follows:

a=Sₒᵤₜ−1=2^{B}−1; b=−1; c=0; and d=0.

For example, the fraction components fcⱼ of the lookup table T1 are computed using the expression:

$$f {c}_{j} = ( {2}^{B} - 1 ) * {2}^{( \frac{- j}{M} )} \qquad ( 4 )$$

Thus, the parameters a, b, c and d for computing the fraction components fcⱼ are adjusted in a way that the largest fraction component is fc₀=2^{B}−1=Sₒᵤₜ−1 and the smallest fraction component is

$$f {c}_{M - 1} = ( {2}^{B} - 1 ) * 2 ( \frac{- ( M - 1 )}{M} ) \approx \frac{{2}^{B}}{2} = \frac{{s}_{o u t}}{2} ( e . g . , close to \frac{{s}_{o u t}}{2} ) .$$

In a first step S11, the data processing device 100 receives a vector of K original input numbers xᵢ. The original input numbers xᵢ may be real values. For example, they may be the real-valued scores at the output of a multi-layer neural network, such as a classification neural network.

In an implementation, typically in a case that the input into the data processing device 100 is an output from a neural network, the original input numbers xᵢ received in the step S11 can be already scaled by an input scaling factor Sᵢₙ=2^{σ} and rounded to an integer (the nearest integer) so as to be stored in N-bit registers. For example, the scaling happens in the input to the neural network which delivers data into a SoftMax operator. In such a case, the scaling happens outside the SoftMax operator. The input scaling factor Sᵢₙ can be chosen depending on the expected smallest and largest values of the original input numbers and the size of the N-bit registers. After scaling by Sᵢₙ, all the scaled numbers xᵢ can advantageously fit −2^{N-1} and 2^{N-1}−1 (in the signed integer representation).

In another implementation, the original input numbers are scaled in the input to the data processing device 100. For example, the original input values xᵢ in the table of FIG. 3A are scaled by 2²⁷ and rounded to the nearest integer to be stored in 32-bit registers. The corresponding decimal values are indicated in the table of FIG. 3B, as an illustrative example.

In a step S12, the processor 101 derives an input number zᵢ from each original (already scaled by Sᵢₙ) input number xᵢ and obtains K input number zᵢ corresponding respectively to the K input numbers xᵢ (positive, negative or zero) with i=1, . . . , K. The first implementation is a positive approach, which means that the input numbers zᵢ are positive or zero. Thus, in the first implementation, deriving each input numbers zᵢ from the original input number xᵢ includes selecting the maximal original input number xₘₐₓ and subtracting xᵢ from xₘₐₓ so as to obtain a input number zᵢ that is positive or equal to zero. For example, the input numbers zᵢ are calculated based on the expression zᵢ=xₘₐₓ−xᵢ. The K input numbers zᵢ can be stored in the first N-bit registers R1ᵢ by overwriting the original input numbers xᵢ. In further implementations, the K input numbers zᵢ can be stored in other N-bit registers.

FIG. 3A is a table illustrating an example of original input numbers xᵢ in the first column and derived positive input numbers zᵢ (=xₘₐₓ−xᵢ) in the second column. The numbers are represented by decimal values without the scaling by Sᵢₙ, for the sake of clarity.

In a next step S14, the input numbers zᵢ (scaled by Sᵢₙ=2^{σ}) are multiplied by 1/ln(2) (≅1.442695041) to obtain the numbers yᵢ (corresponding to

$${y}_{i} == \frac{{z}_{i}}{ln ( 2 )} ,$$

scaled by Sᵢₙ=2^{σ}). In the first implementation, the multiplication of each zᵢ stored in a N-bit register R1ᵢ, by the constant value 1/ln(2), is optimized by using a cheaper N/2-bit*N/2-bit multiplication resulting in a N-bit result, as explained below. As an illustrative example, N is equal to 32 bits.

The step S14 includes the following steps (or sub-steps), carried out by the processor 101 for each (scaled) input number zᵢ. In a step S140, the processor 101 provides the (scaled) input number zᵢ in the first N-bit register R1ᵢ (in the given example: in the first 32-bit register R1ᵢ). In a step S142, the processor 101 performs a right-shifting of the (scaled) input number zᵢ by N/2−1 into a second N/2-bit register R2ᵢ (in the given example: it is a right-shifting by 15 bits in a second 16-bit register R2ᵢ). For example, the N/2−1 (15 in the given example) less significant bits are discarded by right-shifting. The N/2+1 (17 in the given example) most significant bits are processed according to the following processing rules: (i) if the scaled input number zᵢ, after right-shifting by N/2−1, does not overflow the second N/2-bit register R2ᵢ, fitting the shifted number zᵢ into said second N/2-bit register R2ᵢ. It means that, when N is equal to 32 for example, if the most significant bit (the 32^{th} bit) of the number zᵢ is 0, the 16 least significant of the 17 bits of the scaled number zᵢ right-shifted by 15 are simply transferred into the second N/2 bit register R2ᵢ; and (ii) if the scaled input number zᵢ, after right-shifting by N/2−1, overflows the second N/2-bit register R2ᵢ saturating said second N/2-bit register R2ᵢ. It means that if the most significant (the N^{th} bit) bit of zᵢ is 1, each of the other N/2 (e.g., 16) most significant bits (from the (N−1)^{th} to the N/2^{th} bit) are set to 1 and transferred into the second N/2-bit register R2ᵢ that is consequently saturated.

The step S142 results in storing a number referenced as zᵢ″ in the second N/2-bit register R2ᵢ. In the domain of decimal numbers, the step of right-shifting the scaled input number zᵢ by N/2−1 bits corresponds to a division by 2^{N/2-1}.

In an implementation, the right-shifting by N/2−1 of the (scaled) input number zᵢ may be preceded by a rounding step S141 of adding 2^{N/2-2} to the (scaled) input number zᵢ. In this way, the right-shifted number zᵢ, referenced as zᵢ″, can be rounded.

In another step S143, the processor 101 provides (or loads) the constant value of

$$( \frac{1}{ln ( 2 )} - 1 )$$

scaled by 2^{N/2-1} in binary form in a third N/2-bit register R3. The value of

$$( \frac{1}{ln ( 2 )} - 1 )$$

can be precalculated and stored (In an implementation after scaling by 2^{N/2-1}) in memory in the data processing device 100 or calculated in real time, when needed.

In a step S144, the processor 101 calculates the product of the second N/2-bit register R2ᵢ and the third N/2-bit register R3 (e.g., the multiplication of zᵢ″ by

$$( \frac{1}{ln ( 2 )} - 1 )$$

scaled by 2^{N/2-1}) and stores the product result into a fourth N-bit register R4ᵢ. The product result corresponds to

$$( \frac{1}{ln ( 2 )} - 1 ) * {z}_{i} ≅ 0.442695041 * {z}_{i} ,$$

scaled by the input scaling factor Sᵢₙ=2^{σ}.

In a step S145, the processor 101 adds the first N-bit register R1ᵢ and the fourth N-bit register R4ᵢ to obtain the element yᵢ, scaled by the input scaling factor Sᵢₙ, that can be stored into a fifth N-bit register R5ᵢ. In an implementation, the addition S145 can be a saturating addition, which means that if the result of the addition overflows the N-bit register R5ᵢ (e.g., greater than the maximum value in the N-bit register R5ᵢ) all the bits are set to 1 in the N-bit register R5ᵢ (e.g., the N-bit register R5ᵢ can be set to the maximum). The saturation allows to avoid some unreasonable results, such as low probabilities getting very large by numerical overflow due to the two's complement representation. In further implementations, the result of the addition of the step S145 can be overwritten in one of the two N-bit registers R1ᵢ and R4ᵢ.

The step S14 ends by providing the element (number) yᵢ in the binary domain scaled by Sᵢₙ (=2^{σ}). In a first variant, the step S14 of calculating each element yᵢ corresponding to yᵢ==

$$\frac{{z}_{i}}{ln ( 2 )}$$

(here already scaled by Sᵢₙ=2^{σ}) is executed as described below.

As previously described, the scaled input numbers zᵢ are multiplied by 1/ln(2) (≅1.442695041) to obtain the numbers yᵢ. In the first variant, the step S14 includes the following steps (or sub-steps), carried out by the processor 101 for each (scaled) input number zᵢ.

In a step S140′ (identical to the step S140), the processor 101 provides the (scaled) input number zᵢ in the first N-bit register R1ᵢ (in the given example, a 32-bit register).

In a step S142′, the processor 101 performs a right-shifting of the scaled input number zᵢ by N/2-2 in a second N-bit register R2ᵢ (in the given example: it is a right-shifting by 14 bits in a 32-bit register R2ᵢ). For example, the N/2-2 (14 in the given example) less significant bits are discarded by right-shifting. The N/2+2 (18 in the given example) most significant bits are maintained in the first N-bit register R2ᵢ as the N/2+2 least significant bits (the N/2-2 most significant bits are set to 0). The first and the second N-bit register R1ᵢ and R2ᵢ can be the same N-bit register and two distinct N-bit registers. In an implementation, the step S142′ is preceded by a step S141′ of rounding the right-shifted scaled input number zᵢ by adding 2^{N/2-3} to the scaled input number zᵢ before right-shifting by N/2-2.

In a step S143′, the processor 101 provides the value of

$$\frac{1}{ln ( 2 )} - 1$$

in binary form scaled by 2^{N/2-2} in a third register R3.

In a step S144′, the processor 101 multiplies each second N-bit register R2ᵢ and the third register R3 and stores the result into a fourth N-bit register R4ᵢ. This multiplication is more costly in computing resources than a N/2-bit*N/2-bit multiplication as described in step S144. In further implementations, the second N-bit register R2ᵢ (that can be the first register R1ᵢ in case that zᵢ s right-shifted in the same register in the step S142′) can be overwritten by the result of the multiplication (instead of using another N-bit register). For example, the fourth N-bit register R4ᵢ can be the N-bit register R2ᵢ.

In a step S145′, the processor 101 adds the first and the fourth N-bit register R1ᵢ and R4ᵢ to obtain the element yᵢ (scaled by the input scaling factor Sᵢₙ). The addition result yᵢ is stored into a fifth N-bit register R5ᵢ. The processor 101 can implement a saturating addition of the two registers R1ᵢ and R4ᵢ. If the addition result is greater than the maximum value that can be stored in the register R5ᵢ, the N-bit register R5ᵢ is set to the maximum (all the N bits are set to 1 in the register R5ᵢ). Any value of the scaled input number zᵢ or derived from zᵢ can be maintained in the register R1ᵢ until its last use in the step S145′.

In the first variant, there is no need for saturation. The calculation is more precise (because there 1 more bit of precision for the input number) but also a little more costly in computing resources.

In a second variant, the step S14 of calculating each element yᵢ (yᵢ corresponding to

$${y}_{i} == \frac{{z}_{i}}{ln ( 2 )} ,$$

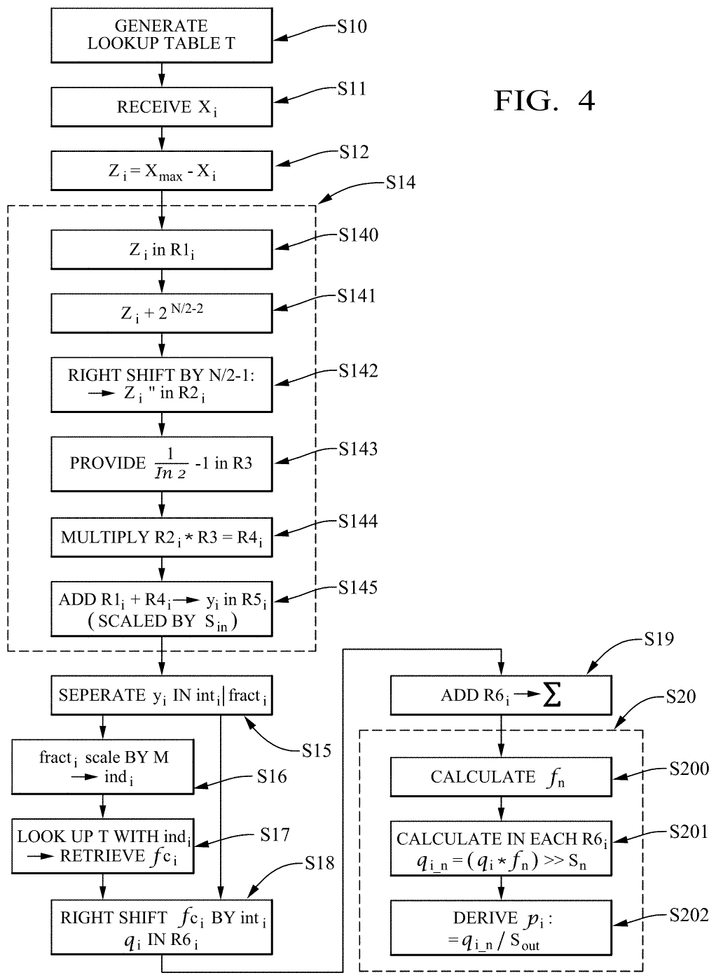

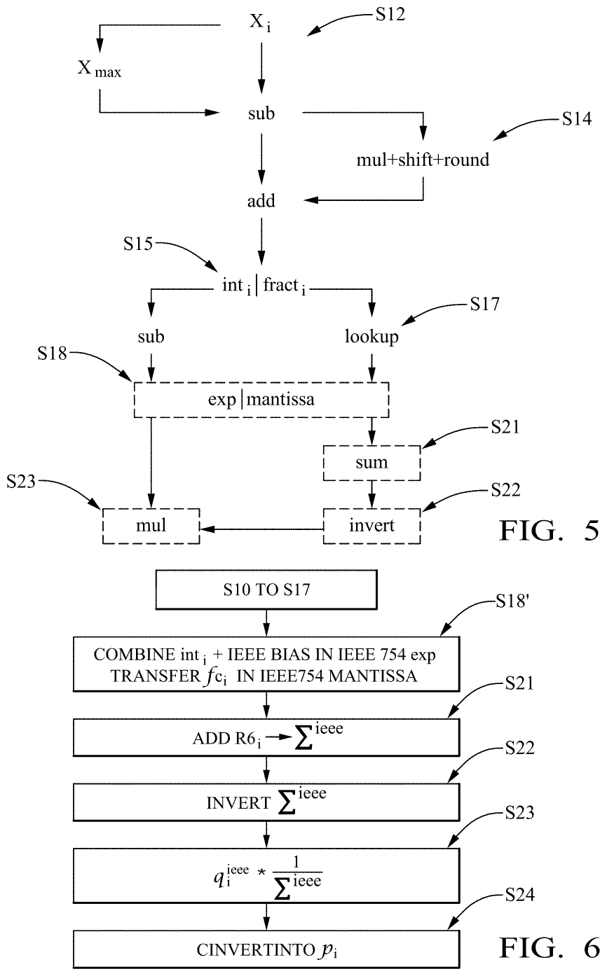

already scaled by Sᵢₙ=2^{σ}) is analogous to the first implementation illustrated in FIG. 4 but differs from it by the following features: (i) in the step S142 of right-shifting, the processor 101 performs a right-shifting of the scaled input number zᵢ by N/2 in a second N/2-bit register R2ᵢ (in the given example: it is a right-shifting by 16 bits in a 16-bit register R2ᵢ); and (ii) in the step S143, the processor 101 provides (loads) the constant value of

$$( \frac{1}{ln ( 2 )} - 1 )$$

scaled by 2^{N/2} in binary form in a third N/2-bit register R3. In at least some implementations, this second variant may be less precise than the first variant.

In a following step S15, the processor 101 separates the integral part intᵢ and the fractional part fracᵢ of the element yᵢ. The integral part intᵢ can be an integer. It can be derived from the register R5ᵢ by right-shifting by a bits (which results in discarding all fractional bits due to the right-shift). The fractional part fracᵢ can be a value that is less than 1, and more than zero or equal to zero (e.g., 0≤fracᵢ<1). It is also derived from the register R5ᵢ for example by masking off the bits corresponding to the integral part.

In a step S16, the processor 101 scales (e.g., multiplies) the fractional part fracᵢ by the size M of the lookup table T1 (the multiplication or scaling result being rounded to the nearest integer) to obtain a lookup index indᵢ, that is an integer between 0 and M−1. The bits for the lookup index indᵢ can be extracted directly from the internal representation of yᵢ (e.g., yᵢ scaled by 2^{σ} which is the content of the register R5ᵢ), via a formula indicating which bits to use and which bits to discard to form the index indᵢ directly.

In the table of FIG. 3A, the third column contains the numerical values of the element yᵢ in the decimal domain, the fourth column contains the corresponding integral parts intᵢ in the decimal domain and the fifth column contains the corresponding fractional part fracᵢ scaled by the size M of the lookup table T1 in the decimal domain, For example the lookup indexes indᵢ (j in the expression (4)).

In a step S17, the processor 101 retrieves from the lookup table T1 the fraction component fcᵢ using the obtained lookup index indᵢ (e.g., the fraction component fcᵢ located in the lookup table T1 at a position j between 0 and M−1 with j=indᵢ).

In the table of FIG. 3A, the sixth column contains the decimal values of the fraction components fcᵢ corresponding to the lookup indexes indicated in the fifth column. However, as previously explained, the fraction components fcᵢ are stored in the lookup table T1 in binary form, scaled by the output scaling factor Sₒᵤₜ=2^{B} (in the present implementation Sₒᵤₜ=2^{N/2}, with N=32 in the given example).

In a step S18, for each input number zᵢ, the processor 101 generates in a sixth N/2-bit register R6ᵢ, termed as a result register, a binary number qᵢ representative of the exponential value of said input number zᵢ, by combining said fraction component fcᵢ retrieved from the lookup table T1 at the step S17 and said integral part intᵢ determined in the step S15.

The first implementation may be a fixed-point or integer approach. It means that all the operations carried out by the processor 101 are fixed-point operations. In the first implementation, generating the binary number qᵢ representative of the exponential value of each input number zᵢ in the N/2-bit result register R6ᵢ includes: inputting the corresponding fraction component fcᵢ retrieved from the lookup table T1 at the step S17 into said result register R6ᵢ, then, right-shifting the fraction component fcᵢ by the integral part intᵢ, in said result register R6ᵢ.

The right-shifting by the integral part intᵢ results in discarding the r less significant bits of the fraction component fcᵢ, where p is a number equal to intᵢ. For large values of the integer component intᵢ, all bits of the result register R6ᵢ become equal to zero. The number resulting from the right-shifting of the step S18 in each result register R6ᵢ, referenced as qᵢ, can be expressed by the following formula:

$${q}_{i} = {2}^{- i n {t}_{i}} * f {c}_{i} = {2}^{- i n {t}_{i}} * ( {2}^{B} - 1 ) * {2}^{( \frac{- j}{M} )} = ( {2}^{B} - 1 ) * {2}^{- ( i n {t}_{i} + \frac{j}{M} )} = ( {2}^{B} - 1 ) * {2}^{- ( i n {t}_{i} + {frac}_{i} )} = ( {2}^{B} - 1 ) * {2}^{- {y}_{i}} == ( {2}^{B} - 1 ) * {e}^{- {z}_{i}} = ( {2}^{B} - 1 ) * {e}^{{x}_{i} - {x}_{max}}$$

As shown by the above relationship, the result number qᵢ is representative of the exponential value of the original input number xᵢ. In the present implementation, it is proportional to the exponential of xᵢ.

In FIG. 3A, the seventh column of the table contains the decimal values of the number qᵢ in each result register R6ᵢ (after the right-shifting of fcᵢ by intᵢ). As shown in the seventh column, all the result registers R6ᵢ corresponding to the non-meaningful original input numbers xᵢ, namely x₃, x₅, x₇, x₁₀ are set to zero.

In a step S19, the processor 101 adds all the result registers R6ᵢ with i varying from 1 to K to obtain a sum number E in a sum register R7 that is a N-bit register. In the illustrative example of the FIG. 3A, the decimal value of the sum Σ is 65993 as shown in FIG. 3C.

Then, in a step S20, the processor 101 normalizes the result registers R6ᵢ (e.g., the values qᵢ in the result registers R6ᵢ), in order to determine the K probability values derived from the K input numbers zᵢ (or from the K original input numbers xᵢ).

The step S20 includes different steps (or sub-steps) S200 to S202. In the first step S200, the processor 101 obtains a normalization factor fₙ calculated according to the following expression:

$${f}_{n} = \frac{( {v}_{100} ≪ {s}_{n} )}{\sum } \qquad ( 5 )$$

where V₁₀₀ represents the value obtained by setting to 1 all bits in a N/2-bit result register R6ᵢ and corresponds to the result qᵢ giving a probability value of 100%; <<Sₙ represents a left-shift by a normalization scaling factor Sₙ used for the normalization, for example N/2 (which corresponds to a scale by 2^{N/2} in the decimal domain); and Σ represents the sum of all result registers R6ᵢ with i varying from 1 to K.

In an implementation, for precision improvement, the factor fₙ can be rounded using the modified expression:

$${f}_{n} = \frac{( {v}_{100} ≪ {s}_{n} + \frac{\sum }{2} )}{\sum } \qquad ( 5 ’ )$$

The normalization factor fₙ can be computed by the processor 101 and stored in a memory 201. With reference to the example in FIGS. 3A-3C, the value V₁₀₀ is 65535, the sum is 65993, the scaling factor is 16 and the normalization factor fₙ is given by the following expression:

$${f}_{n} = \frac{( 65535 ≪ 16 + \frac{65993}{2} )}{65993} = 65082.$$

Then, in a step S201, the normalization factor fₙ is applied to each result register R6ᵢ with a rescaling by the factor 1/Sₙ, to obtain a normalized value q_{i_n} in the result register R6ᵢ. The operation of the step S201 can be expressed as follows:

q_{i_n}=(qᵢ*fₙ)>>Sₙ

where qᵢ is the binary value in the result register R6ᵢ; fₙ is the normalization factor; and >>Sₙ represents a right-shift by Sₙ in the result register R6ᵢ.

The operation of step S201 can be combined with a rounding to the nearest integer by adding 2^{S}^{ₙ}⁻¹ to qᵢ*fₙ before right-shifting by Sₙ in the result register R6ᵢ.

FIG. 3C illustrates the registers R6ᵢ before and after normalization S20. It can be seen that the sum of the normalized elements q_{i_n} is 65636 which corresponds to a total probability that is very close to 100% (only very slightly more than 100% by 1). The eighth column of the table contains the decimal values of the numbers q_{i_n}.

In an optional step S202, the processor 101 can derive from the normalized values q_{i_n} in the result registers R6ᵢ the respective probability values pᵢ (that are decimal numbers) corresponding to the input values xᵢ, by dividing the normalized values q_{i_n} in the result registers R6ᵢ by the output scaling factor Sₒᵤₜ (2¹⁶ in the example of FIGS. 3A-3C). The ninth column of the table in FIG. 3A contains the probability values pᵢ expressed in %. The sum of the percentage is very slightly more than 100% (100,0783%).

In the first implementation, the processor 101 executes mainly integer (fixed-point) operations and some shifts in registers, which allows to determine the probability values pᵢ corresponding to the input numbers xᵢ in a fast manner. The run time and energy consumption of the processor 101 are significantly reduced. Furthermore, a microcontroller without capacity for floating-point calculation can easily use the SoftMax function according to the present disclosure.

A second implementation, that can be termed as a positive and floating-point approach, may now be described with reference to FIG. 6. The second implementation is based on the first implementation and only varies from the first implementation by the features described below.

In the second implementation, the steps S10 to S17 described in connection with the first implementation are performed, but the lookup table T2 used in the second implementation is a different variant of the lookup table T defined by the expression (3).

In the second implementation, the constant parameters of the expression (3) for computing the fraction components fcⱼ of the lookup table T2 are set as follows:

a=2*Sₒᵤₜ−2=2^{B+1}−2; b=−1; c=0; d=Sₒᵤₜ−1=2^{B}−1

For example, the fraction components fcⱼ of the lookup table T2 are computed using the expression:

$$f {c}_{j} = ( {2}^{B + 1} - 2 ) * {2}^{( \frac{- j}{M} )} - ( {2}^{B} - 1 ) \qquad ( 6 )$$

Thus, the parameters a, b, c and d for computing the fraction components fcⱼ are adjusted in a way that the largest fraction component is fc₀=2^{B}−1=Sₒᵤₜ−1 and the smallest fraction component is:

$$f {c}_{M - 1} = ( {2}^{B + 1} - 2 ) * {2}^{( \frac{- ( M - 1 )}{M} )} - ( {2}^{B} - 1 ) \approx 0 .$$

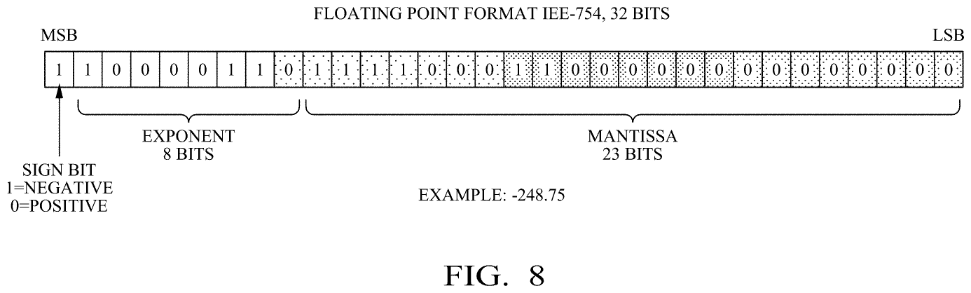

In the second implementation, the step S18′ of generating a binary number qᵢ representative of the exponential value of each input number zᵢ, in a N/2-bit result register R6ᵢ, by combining the fraction component fcᵢ retrieved from the lookup table T2 at the step S17 and the integral part intᵢ determined in the step S15 is different from the step S18 of the first implementation, due to the fact that the second implementation is a floating-point approach. It means that all the binary numbers representative of the exponential values of the input numbers zᵢ are floating-point numbers, here IEEE 754 floating-point numbers. They are referred as qᵢ^{ieee}. According to the IEEE standard for Floating-Point Arithmetic (IEEE 754), a N-bit floating point has a layout defined by one sign bit (the most significant bit), a N1-bit exponent part and a N2-bit mantissa. FIG. 8 illustrates an example of a layout for a 32-bit floating point number (−248,75), as defined by the standard IEEE 754. The exponent is a 8-bit part and the mantissa is a 23-bit part. N-bit registers can be used to store the numbers qᵢ^{ieee} and, for example, N=32 bits.

In the second implementation, generating the binary floating-point number qᵢ^{ieee} representative of the exponential value of each input number zᵢ in the N-bit result register R6ᵢ in the step S18 includes: (i) combining the integral part intᵢ determined in the step S15 and the IEEE 754 exponent bias (here by subtracting the integral part intᵢ from the bias) and transferring the integral part intᵢ combined with the IEEE 754 exponent bias in the exponent part of the floating-point number qᵢ^{ieee}, in the N-bit result register R6ᵢ; and (ii) transferring the fraction component fcᵢ retrieved from the lookup table T2 at the step S17 into the mantissa of the floating-point number qᵢ^{ieee} in the N-bit result register R6ᵢ, if needed by adding bits set at 0 on the least significant bits. For example, if the fraction component fcᵢ is represented by 16 bits, it is transferred to the 16 most significant bits of the mantissa and the other least significant bits of the mantissa are set to 0.

Thus, the exponent of qᵢ^{ieee} is a combination of the integral part intᵢ stored in binary form in said result register R6ᵢ and the IEEE 754 exponent bias, and the mantissa of qᵢ^{ieee} is directly derived from the fraction component fcᵢ retrieved from the lookup table T2.

In the second implementation, the parameters a, b, c and d for computing the fraction components fcⱼ of the lookup table T2 are adjusted in a way they match IEEE 754 fraction components, which means that the fraction components fcⱼ are identical or directly transformable from one to the other, for example by simply adding 0 on the right.

Then, in a step S21, the processor 101 adds the result registers R6ᵢ with i varying from 1 to K by performing a floating-point addition, to obtain a sum Σ^{ieee} (floating-point number) in a register R7.

In a step S22, the processor 101 calculates the inverse of the sum Σ^{ieee} and stores the result

$$\frac{1}{{\sum }^{i e e e}}$$

in a register R8 (in floating-point).

In a step S23, the processor 101 multiplies each result register R6ᵢ by the register R8. For example, the product of each result element qᵢ^{ieee} by

$$\frac{1}{{\sum }^{ieee}}$$

is calculated. The result can be stored in a register R8ᵢ that is a N-bit register.

In a step S24, the decimal probability values pᵢ corresponding to the original input numbers xᵢ can be obtained by converting the floating-point numbers stored in the registers R8ᵢ into decimal values.

In the second implementation, the efforts to use floating points are also reduced. The processor 101 calculates more in fixed points and less in floating points than in the prior art.

A third implementation, that can be termed as a negative and integer approach, may now be described. The third implementation is based on the first implementation and only varies from the first implementation by the features described below.

The third implementation mainly differs from the first implementation by the features that each input number zᵢ is negative or zero and derived from the original input number xᵢ by subtracting xₘₐₓ from xᵢ so as to obtain input number zᵢ;

the lookup table T3 is another variant of the lookup table defined by the general expression (3).

In the third implementation, the constant parameters of the expression (3) for computing the fraction components fcᵢ of the lookup table T3 are set as follows:

$$a = \frac{{s}_{o u t}}{2} = {2}^{B - 1} ; b = + 1 ; c = 0 ; d = 0 .$$

For example, the fraction components fcⱼ of the lookup table T2 are computed using the expression:

$$f {c}_{j} = {2}^{B - 1} * {2}^{( \frac{j}{M} )} \qquad ( 7 )$$

Thus, the parameters a, b, c and d for computing the fraction components fcⱼ are adjusted in a way that the smallest fraction component is

$$f {c}_{0} = {2}^{B - 1} = \frac{{s}_{o u t}}{2}$$

and the largest fraction component is:

$$f {c}_{M - 1} = {2}^{B - 1} * {2}^{( \frac{M - 1}{M} )} \approx {2}^{B} = {S}_{out} .$$

In the third implementation, the steps S10 to S20 described in connection with the first implementation are performed, with the only differences indicated above.

A fourth implementation, that can be termed as a negative and fixed-point approach, may now be described. The fourth implementation is based on the second (fixed-point) implementation and only varies from the second implementation by the features described below.

The fourth implementation mainly differs from the second implementation by the features that each input number zᵢ is negative or zero and derived from the original input number xᵢ by subtracting xₘₐₓ from xᵢ so as to obtain input number zᵢ and the lookup table T4 is another variant of the lookup table defined by the general expression (3).

In the fourth implementation, the constant parameters of the expression (3) for computing the fraction components fcⱼ of the lookup table T4 are set as follows:

a=Sₒᵤₜ=2^{B}; b=+1; c=0; d=Sₒᵤₜ=2^{B}.

For example, the fraction components fcⱼ of the lookup table T4 are computed using the expression:

$$f {c}_{j} = {2}^{B} * {2}^{( \frac{j}{M} )} - {2}^{B}$$

Thus, the parameters a, b, c and d for computing the fraction components fcⱼ are adjusted in a way that the smallest fraction component is fc₀=0 and the largest fraction component is

$${fc}_{M - 1} = {2}^{B} * {2}^{( \frac{M - 1}{M} )} - {2}^{B} \approx {2}^{B} = {S}_{out} .$$

In the fourth implementation, the steps S10 to S18 and S21 to S24 described in connection with the second implementation are performed, with the only differences indicated above.

In the step S18, combining the integral part intᵢ and the IEEE 754 exponent bias may consist in either subtracting the integral part intᵢ from the IEEE 754 exponent bias or adding the integral part intᵢ and the IEEE 754 exponent bias, depending on the sign of the integral part intᵢ. In case that the input value zᵢ is positive (as in the second implementation), the int integral part intᵢ is subtracted from the IEEE 754 exponent bias. But, in case that the input value zᵢ is negative, the integral part intᵢ is added to the IEEE 754 exponent bias, as in the fourth implementation.

A fifth implementation, that can be termed as a negative, 0.5, integer approach, may now be described. The fifth implementation is based on the first implementation and only varies from the first implementation by the use of another variant of the lookup table T5 defined by the general expression (3).

In the fifth implementation, the constant parameters of the expression (3) for computing the fraction components fcⱼ of the lookup table T5 are set as follows:

$$a = {S}_{out} = {2}^{B} ; \\ b = - 1 ; \\ c = \frac{- 0.5}{M} ; \\ and \\ d = 0.$$

For example, the fraction components fcⱼ of the lookup table T5 are computed using the expression:

$${fc}_{j} = {2}^{B} * {2}^{( \frac{- j - 0.5}{M} )} \qquad ( 7 )$$

Thus, the parameters a, b, c and d for computing the fraction components fcⱼ are adjusted in a way that the largest fraction component is fc₀≈2^{B}=Sₒᵤₜ and the smallest fraction component is:

$${fc}_{M - 1} = {2}^{B} * {2}^{( \frac{- M + 0.5}{M} )} \approx \frac{{2}^{B}}{2} = \frac{{S}_{out}}{2} .$$

In the fifth implementation, the steps S10 to S20 described in connection with the first implementation are performed, with the only differences indicated above.

A sixth implementation, that can be termed as a negative, 0.5, fixed-point approach, may now be described. The sixth implementation is based on the second implementation and only varies from the second implementation by the use of another variant of the lookup table T6 defined by the general expression (3).

In the sixth implementation, the constant parameters of the expression (3) for computing the fraction components fcⱼ of the lookup table T6 are set as follows:

$$a = 2 * {S}_{out} = {2}^{B + 1} ; \\ b = - 1 ; \\ c = \frac{- 0.5}{M} ; \\ and \\ d = {S}_{out} = {2}^{B} .$$

For example, the fraction components fcⱼ of the lookup table T6 are computed using the expression:

$${fc}_{j} = {2}^{B + 1} * {2}^{( \frac{- j - 0.5}{M} )} - {2}^{B} \qquad ( 7 )$$

Thus, the parameters a, b, c and d for computing the fraction components fcⱼ are adjusted in a way that the largest fraction component is fc₀≈2^{B}=Sₒᵤₜ and the smallest fraction component is:

$${fc}_{M - 1} = {2}^{B + 1} * {2}^{( \frac{- M + 0.5}{M} )} - {2}^{B} \approx 0.$$

In the sixth implementation, the steps S10 to S18 and S21 to S24 described in connection with the second implementation are performed, with the only differences indicated above.

The lookup tables storing fraction components fcⱼ derived from the expression

$${2}^{( \frac{j}{N} )} ,$$

with b=+1, and the lookup tables storing fraction components fcⱼ derived from the expression

$${2}^{( \frac{- j}{N} )} ,$$

with b=−1, basically store identical numbers but in opposite order (potentially with some shift by the constant c).

In the fixed-point (or integer) approaches (first, third and fifth Implementations), the constant parameter d is set to zero.

For stability improvement, all operations with a potential to overflow a register (like additions, subtractions, clipping from N/2+1 to N/2 bits) should be implemented as saturating operations. For example, if the result of an operation in a register is greater than the maximum value that can be stored in said register, the register is set to the maximum (all the register bits are set to one.

For precision improvement, all divisions (including any division implemented by performing a right-shift in a register) are preferably rounded, by adding half the divisor to the dividend. For example, any division of the type “a divided by b” is advantageously executed by adding ‘b/2’ to the dividend ‘a’ before dividing by the divisor ‘b’ (or performing a corresponding right-shift in a register).

The present disclosure also concerns: a computer program including instructions which, when the program is executed by a computer, cause the computer to carry out the steps of the method according to any of the implementations previously defined; a data processing device including a processor in charge of performing the steps of the method according to any of the implementations previously defined.

What is claimed is:

1. A computer-implemented method of executing a SoftMax function, the computer-implemented method comprising:
pre-storing, in a memory, M fraction components (fcⱼ) in binary form, derived from an expression 2^{(j/M)}, where j is an integer varying from 0 to M−1, and where the fcⱼ form a lookup table (T) of size M;
calculating, for each input number (zᵢ), an element yᵢ of a number of a form 2^{y}ᵢ, where the element yᵢ represents
$$\frac{{z}_{i}}{ln ( 2 )} ;$$
separating the element yᵢ into an integral part (intᵢ) and a fractional part (fractᵢ);
determining a lookup index (indᵢ) that corresponds to fractᵢ scaled by the size M;
retrieving a fraction component (fcᵢ) from T with the indᵢ;
generating, in a result register, a binary number (qᵢ) representative of an exponential value for each zᵢ, by combining fcᵢ retrieved from the T and intᵢ;
adding K result registers corresponding to K input numbers zᵢ into a sum register; and
determining K probability values pᵢ from the K result registers and the sum register.

2. The computer-implemented method as described in claim 1, wherein each zᵢ in binary form is scaled by an input scaling factor (Sᵢₙ) effective to produce a corresponding scaled input number zᵢ, where Sᵢₙ=2^{σ} is stored in a first N-bit register.

3. The computer-implemented method as described in claim 2, wherein Sᵢₙ is determined depending on an expected smallest and largest values of zᵢ and a size N of the first N-bit registers.

4. The computer-implemented method as described in claim 3, wherein calculating each element yᵢ further comprises:
providing the corresponding scaled input number zᵢ in the first N-bit register;
right-shifting the corresponding scaled input number zᵢ by N/2−1, effective to produce a right-shifted scaled input number zᵢ; and
processing the right-shifted scaled input number zᵢ effective to provide a transformed input number zᵢ″ into a second N/2-bit register.

5. The computer-implemented method as described in claim 4, wherein processing the right-shifted scaled input number zᵢ is processed according to at least one of the following conditions:
if the scaled input number zᵢ, after right-shifting by N/2−1, does not overflow the second N/2-bit register, fitting the shifted scaled input number zᵢ into said second N/2-bit register; or
if the scaled input number zᵢ, after right-shifting by N/2−1, overflows the second N/2-bit register, saturating said N/2 bit register, providing the value of
$$( \frac{1}{ln ( 2 )} - 1 )$$
scaled by 2^{N/2-1} in binary form in a third N/2-bit register.

6. The computer-implemented method as described in claim 5, further comprising:
calculating a product of the second and third N/2-bit registers; and
storing the product into a fourth N-bit register.

7. The computer-implemented method as described in claim 6, further comprising adding the first N-bit register and the fourth N-bit register by implementing a saturating addition, to obtain an element yᵢ that is scaled by Sᵢₙ in a fifth N-bit register.

8. The computer-implemented method as described in claim 7, wherein calculating each element yᵢ, further includes rounding the right-shifted scaled input number zᵢ″ by adding 2N/2-2 to the scaled input number zᵢ before right-shifting by N/2−1.

9. The computer-implemented method as described in claim 1, further comprising:
computing the fcⱼ of T, with j varying from 0 to M−1, by using the following formula:
$${fc}_{j} = a * {2}^{( b * ( \frac{j}{M} ) + c )} - d ,$$
and wherein a, b, c, and d are constant parameters for which a includes an output scaling factor Sₒᵤₜ is equal to ^{2B} and B is a number of desired bits for the computed exponential values, b is either 1 or −1, and d is a multiple of a, and the constant parameters a, b, c, and d for computing the fraction components the fcⱼ are adjusted in a way that the largest fraction component is equal or close to 2^{B}−1.

10. The computer-implemented method as described in claim 9, wherein the binary number qᵢ representative of the exponential value for each zᵢ is generated by inputting a corresponding fcᵢ retrieved from T into the result register and right-shifting fcᵢ by intᵢ in the result register.

11. The computer-implemented method as described in claim 10, wherein parameters a, b, c, and d for computing fraction components of T are adjusted in a way that the smallest fraction component is close to 2^{B}/2, and parameter d is equal to zero.

12. The computer-implemented method as described in claim 11, wherein determining the K probability values pᵢ derived from the K input numbers zᵢ comprises:
adding the result registers with i varying from 1 to K to obtain a sum number; and
obtaining a normalization factor (fₙ) by scaling a value V₁₀₀, obtained by setting to 1 all bits in a result register and corresponding to a result qᵢ giving a probability value of 100% by a normalization scaling factor (Sₙ).

13. The computer-implemented method as described in claim 12, wherein obtaining fₙ is obtained using the following formula:
$${f}_{n} = \frac{( {V}_{100} ≪ {S}_{n} )}{Σ} .$$

14. The computer-implemented method as described in claim 1, wherein qᵢ is generated in the result register in a form of an Institute of Electrical and Electronics Engineers (IEEE) 754 floating-point number including an exponent and an IEEE 754 mantissa.

15. The computer-implemented method as described in claim 14, wherein the exponent is a combination of intᵢ in binary form and an IEEE 754 exponent bias.

16. The computer-implemented method as described in claim 14, wherein the IEEE 754 mantissa is derived from fcᵢ retrieved from T.

17. The computer-implemented method as described in claim 14, wherein parameters a, b, c, and d for computing fcᵢ of T are adjusted in a way that the fcᵢ of T match the IEEE 754 mantissa.

18. The computer-implemented method as described in claim 1, further comprising:
selecting a maximal input number xₘₐₓ; and
performing, for each zᵢ, at least one of the following:
subtracting xₘₐₓ from an original input number to obtain a negative or zero input number; or
subtracting the original input number from xₘₐₓ to obtain a zero or positive input number.

19. A non-transitory computer-readable storage medium storing one or more programs comprising instructions, which when executed by a processor, cause the processor to perform operations including:
pre-storing, in a memory, M fraction components (fcⱼ) in binary form, derived from an expression 2^{(j/M)}, where j is an integer varying from 0 to M−1, and where the fcⱼ form a lookup table (T) of size M;
calculating, for each input number (zᵢ), an element yᵢ of a number of a form 2^{y}ᵢ, where the element yᵢ represents
$$\frac{{z}_{i}}{ln ( 2 )} ;$$
separating the element yᵢ into an integral part (intᵢ) and a fractional part (fractᵢ);
determining a lookup index (indᵢ) that corresponds to fractᵢ scaled by the size M;
retrieving a fraction component (fcᵢ) from T with the indᵢ;
generating, in a result register, a binary number (qᵢ) representative of an exponential value for each zᵢ, by combining fcᵢ retrieved from the T and intᵢ;
adding K result registers corresponding to K input numbers zᵢ into a sum register; and
determining K probability values pᵢ from the K result registers and the sum register.

20. A system comprising:
one or more processors; and
a memory coupled to the one or more processors, the memory storing one or more programs configured to be executed by the one or more processors, the one or more programs including instructions that, when executed by the one or more processors, cause the one or more processors to:
pre-store, in a memory, M fraction components (fcⱼ) in binary form, derived from an expression 2^{(j/M)}, where j is an integer varying from 0 to M−1, and where the fcⱼ form a lookup table (T) of size M;
calculate, for each input number (zᵢ), an element yᵢ of a number of a form 2^{y}ᵢ, where the element yᵢ represents
$$\frac{{z}_{i}}{ln ( 2 )} ;$$
separate the element yi into an integral part (inti) and a fractional part (fracti);
determine a lookup index (indᵢ) that corresponds to fractᵢ scaled by the size M;
retrieve a fraction component (fcᵢ) from T with the indᵢ;
generate, in a result register, a binary number (qᵢ) representative of an exponential value for each zᵢ, by combining fcᵢ retrieved from the T and intᵢ;
add K result registers corresponding to K input numbers zᵢ into a sum register; and
determine K probability values pᵢ from the K result registers and the sum register.
